(19) United States
(12) Patent Application Publication
(10) Pub. No.: US 2004/0255018 A1
(43) Pub. Date: Dec. 16, 2004

(54) Method and apparatus for providing universal web access functionality with port contention resolution

(76) Inventor: Brian Taraci, Foothill Ranch, CA (US)

Correspondence Address: THE HECKER LAW GROUP, 1925 CENTURY PARK EAST, SUITE 2300, LOS ANGELES, CA, 90067, US

(21) Appl. No.: 10/797,852

(22) Filed: Mar. 10, 2004

Related U.S. Application Data
(63) Continuation-in-part of application No. 10/678,605, filed on Oct. 3, 2003.
(60) Provisional application No. 60/416,101, filed on Oct. 4, 2002.

(51) Int. Cl. G06F 15/173; G06F 15/16

(52) U.S. Cl. 709/223; 709/230

(57) ABSTRACT

A flexible electronic asset management system using Ethernet connectivity for electronic devices is presented. The invention enables multiple electronic devices to be controlled, monitored, and accessed from any browser connected to a computer network. A contention manager enables multiple services to share common communication ports in real time, on an as-needed basis. A pass-through condition may be created whereby the management system may be inserted into a pre-existing communication path for implementation of access, monitoring and/or control, without disrupting the pre-existing communication.

### CROSS REFERENCE TO RELATED APPLICATIONS

This application is a continuation-in-part of U.S. Non-provisional application Ser. No. 10/678,605, filed on Oct. 3, 2003, which claims priority from U.S. Provisional Application No. 60/416,101 filed on Oct. 4, 2002, the specification of which is herein incorporated by reference.

### BACKGROUND OF INVENTION

1. Field of the Invention

This invention relates to the field of electronic system management. More specifically the invention relates to web based management and control of electronic equipments.

2. Background Art

Electronic appliances have become ubiquitous in the home and workplace, to the point where very few tasks exist without some form of electronic component. Most electronic appliances are initially designed for a particular purpose, with little foresight into secondary issues such as monitoring and control. However, as an electronic appliance evolves, such secondary issues are frequently addressed with new designs that improve efficiency and convenience through enhanced monitoring and control capabilities. For example, televisions initially were controlled by manual operation of control knobs on the set box, but evolution of the television design has brought about the IR remote control, allowing a viewer to change channels without leaving his seat.

Unfortunately, those new control designs are frequently proprietary in nature, targeted solely at the subject appliance with no consideration for other possible electronic appliances in the same environment. Also, unlike the common television viewer scenario, it is often desired to monitor and control electronic appliances from a more remote vantage point. For example, as business enterprises expand their use of electronic appliances, the need arises for the capability to monitor and control multiple appliances from a centralized location within the corporate environment, which may span the world.

Systems of the prior art that attempt to overcome some of these obstacles generally focus narrowly on a specific electronic appliance and design a proprietary monitoring and control system that allows a person using a dedicated electronic controller to communicate with a single piece of electronic equipment. Where no communication path exists, this solution often entails installing a dedicated wiring system to accomplish monitoring and control. Where a network exists, some systems of the prior art use the network to pass proprietary communication packets between the controller and the electronic appliance. To control multiple appliances, additional communication packets must be transmitted across the network. This leads to undesired levels of control traffic on corporate networks as the number of appliances in an enterprise increases.

Another drawback to prior art systems is that they frequently use a computer workstation or other stationary device as the dedicated controller. This detracts from use of the workstation for other purposes, as well as making it difficult to have monitoring and control capabilities from any other location, absent the inefficient use of redundant, dedicated controllers.

For the foregoing reasons, it is desirable to have a monitoring and control system that permits a person to monitor and control multiple electronic appliances of multiple types, where such monitoring and control capability is available from more than one location, where computing resources are not limited by the dedicated use of those resources for proprietary systems, and where impact on network traffic can be minimized by centralizing control of multiple appliances.

### SUMMARY

The present invention provides a solution to the prior art issues discussed above by providing flexible Ethernet connectivity for electronic devices. This enables multiple electronic devices to be controlled, monitored, and accessed from any browser connected to a computer network, e.g., local area network (LAN), wide area network (WAN), or the Internet. Embodiments of the invention provide Internet Protocol (IP) connectivity for monitoring and controlling dumb (no processing power) and smart devices ranging from simple home appliances such as televisions, stereos, alarms, etc, to complex industrial applications such as multiple projectors, plasma displays, switchers, and other electronic products.

A user may configure embodiments of the present invention to provide information needed for proactive service and support for preventive maintenance using such conveniences as e-mail notification. With e-mail notification, technical support administrators can receive failure and service messages through an e-mail enabled cell phone, personal digital assistant (PDA), pager, or Internet e-mail account. For secure installations that do not allow Internet access, online monitoring can still be performed proactively. Within an existing secure infrastructure, e-mail notification of failures and repairs is possible without compromising system or facility security.

The present invention provides dynamically configurable web pages for asset management. For instance, a user may program the invention to dynamically obtain device and/or equipment status when its web page is requested by a web browser. Requests from a web browser may be sent via URL encoding or other transfer mechanism. Upon receiving the request, the data is parsed to determine what information is requested, or what action to take.

Processing of and dynamic creation of web pages are fast because embodiments of the invention use a flattened network stack for network traffic processing instead of the traditional seven layer OSI (International Standards Organization) stack. A flattened stack allows for faster processing of network traffic to determine if the information contained in the traffic is of interest. The flattened stack approach treats the data as one long piece of flattened data. By contrast, the seven layer model requires processing at various layers before the actual data is retrieved at the seventh layer (i.e. the Application Layer). A flattened stack allows one to immediately check the first one or two bytes of data to determine and obtain information of interest without the added burden of processing in the previous six network layers of the OSI model.

The lowest layer of the OSI stack has knowledge of what applications are active in the upper layers, thus the flattened stack allows the packet to be discarded at the earliest possible point so no processing power is wasted. The flattened stack implementation organizes its check/processing based on the raw data stream thus minimizing buffer requirements and providing for easier implementation into hardware.

Embodiments of the invention may provide one or more input/output (I/O) ports for connection to electronic appliances. For instance, an embodiment may include configurable I/O ports for analog or digital I/O signals; serial ports such as RS-232, RS-422, and RS-485; and infrared (IR) ports for controlling virtually any IR controllable device.

One or more embodiments may also implement a contention manager for mediating port control between two or more services requesting control of the same port. For example, services executing within an embodiment of the invention may request port control using a request format that specifies one or more communication parameters by which the contention manager may determine when the specified port is no longer in use by the requesting service. The contention manager may then give control over that port to a waiting service. Examples of such communication parameters may include timeout values, such as maximum amount of time before receipt of response data on the given port or maximum time between received characters; maximum data lengths (e.g., in bytes), and/or a termination symbol specifying the end of the data.

Some embodiments of the invention also provide a pass-through condition in which a service requests a pass-through connection between two communication ports. The request may, for example, include communication parameters as stated above, as well as identifiers for the two requested ports. Implementation of the pass-through condition may allow the apparatus of the present invention to be inserted between an existing controller and a controlled device, without requiring reprogramming of the controller. The apparatus of the present invention may then use the same communication link to monitor and/or control the controlled device.

### BRIEF DESCRIPTION OF DRAWINGS

FIG. 1 is an example layout of a web-enabled access and control architecture for multiple electronic devices, in accordance with an embodiment of the present invention.

FIG. 2 is a top level block diagram of the web-serving device 100 in accordance with an embodiment of the present invention.

FIG. 3 is an illustration of a graphical user interface for configuring the serial port transceiver.

FIG. 4 is an illustration of a browser interface for configuring flexible I/O ports.

FIG. 5 is a circuit schematic illustrating the configurability of the Flex I/O ports in accordance with one embodiment of the invention.

FIG. 6 is an illustration of an example Generalized Graphical User Interface in accordance with an embodiment of the present invention.

FIG. 7 is an example web page that may be created for control of a Samsung™ LCD monitor.

FIG. 8 provides another illustration of a web page associated with the control functionality.

FIG. 9 is an illustration of a monitor web page for the Samsung™ SyncMaster monitor.

FIG. 10 is an illustration of a scheduling web page for the example Samsung™ SyncMaster monitor.

FIGS. 11A and 11B is an illustration of a power scheme in accordance with embodiments of the present invention.

FIG. 12 is a block diagram illustrating, in accordance with an embodiment of the invention, a firmware/software configuration of a web server device that may be implemented using the CPU and memory hardware previously described.

FIG. 13 is an illustration of the flattened stack in accordance with embodiments of the present invention.

FIG. 14 illustrates reduction processing of Ethernet packets by making the drop/process decision immediately using the flattened stack approach, in accordance with embodiments of the present invention.

FIG. 15 is a flow diagram illustrating a method for contention management in accordance with one or more embodiments of the invention.

FIG. 16 is a block diagram illustrating implementation of a command pass-through condition, in accordance with one or more embodiments of the invention.

### DETAILED DESCRIPTION

The present invention is a method and apparatus for providing Web-based interfaces for electronic appliances. In the following description, numerous specific details are set forth to provide a more thorough description of the present invention. It will be apparent, however, to one skilled in the art, that the present invention may be practiced without these specific details. In other instances, well known features have not been described in detail so as not to obscure the present invention.

The present invention provides an apparatus with flexible Ethernet connectivity for electronic devices, enabling multiple electronic devices to be controlled, monitored, and accessed from any browser connected to a computer network, e.g., local area network (LAN), wide area network (WAN), or the Internet. Embodiments of the invention provide Internet Protocol (IP) connectivity for monitoring and controlling devices ranging from simple home appliances such as televisions, stereos, alarms, etc, to complex industrial applications such as multiple projectors, plasma displays, switchers, and other electronic products.

Internet Protocol (IP) connectivity provides the ability to remotely and proactively monitor and troubleshoot various types of electronic equipment. Embodiments of the present invention may provide Ethernet connectivity to electronic devices that are not otherwise “Web enabled,” eliminating the necessity for electronics manufacturers to web-enable every piece of electronic equipment.

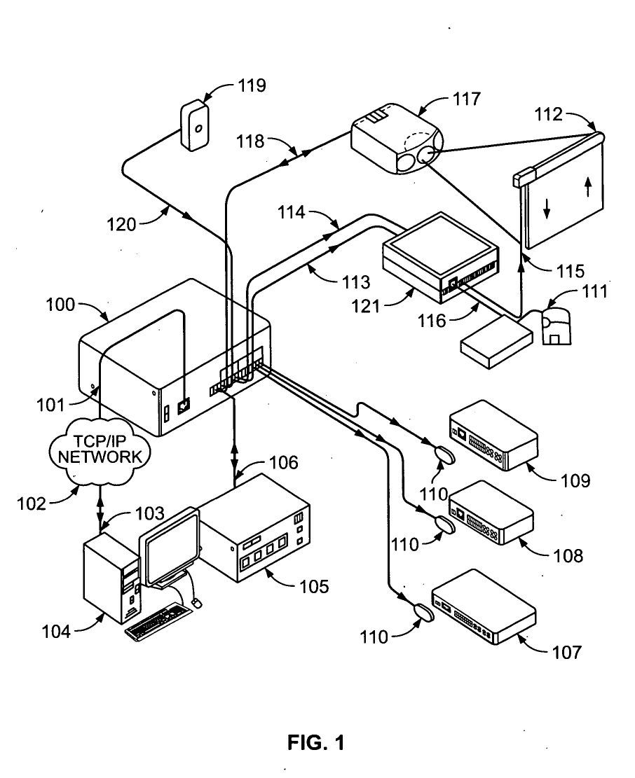

By providing Web connectivity via an embodiment of the invention, such as device 100 of FIG. 1, a variety of electronic products can be managed and supported by a user, technician, or administrator at any time from any computer with a web browser. For instance, an audio/visual (A/V) technician can control presentations thousands of miles from the presentation location. The technician can also monitor the health of the equipment in order to provide proactive service. For example, a user can check the activity and status of a projector's power, connections, lamp life, or temperature, or even turn off multiple projectors at once—all from the convenience of any Web-enabled monitoring station. In the case of lamp life, a technician can monitor the projector lamp life for one or more projectors, from his office or other location, and order replacement lamps when the useful life of the lamps are about to expire, thus preventing service interruption.

Proactive service, support and preventive maintenance may be provided through such conveniences as e-mail notification. With e-mail notification, technical support administrators can receive failure and service messages through an e-mail enabled cell phone, personal digital assistant (PDA), pager, or Internet e-mail account. For secure installations that do not allow Internet access, online monitoring can still be performed proactively. Within an existing secure infrastructure, e-mail notification of failures and repairs is possible without compromising system or facility security.

In one or more embodiments of the present invention, a web server is configured with random access memory for storing a large number of device drivers, web pages, and other software, which may be in the form of Hyper-Text Markup Language (HTML), JavaScript, Flash™ animation, and/or graphics files. Customizable web pages can be created and stored using off-the-shelf software programs such as Macromedia® Dreamweaver and Microsoft FrontPage®. Using intuitive Web-based software with a graphical user interface (GUI), users can access a variety of electronic equipment through embodiments of the present invention.

FIG. 1 is an example layout of a web-enabled access and control architecture for multiple electronic devices, in accordance with an embodiment of the present invention. In this illustration, device 100 comprises the engine or Web Server of the present invention. The configuration of device 100 may include any combination of input/output ports and may be embedded into electronic equipment or as a standalone server. For instance, in the standalone configuration shown in FIG. 1, device 100 has multiple infrared (IR) ports connecting device 100 to IR emitters 110. In this embodiment, the IR ports are output ports which drive the IR emitters 110 for controlling electronic devices such as VCR 109, DVD 108, and Digital Satellite System (DSS) Receiver 107.

Embodiments of the present invention may also include input/outputs such as RS-232 serial ports and other general purpose ports. For instance, device 100 includes RS-232 ports for controlling ANV equipment, such as switcher 105 through serial cable 106, and projector 117 through serial cable 118. The general input/output ports may be used to couple device 100 to relay box 121 through cables 113 and 114. in turn, relay box 121 controls display screen 112 through cable 115 and lighting system 111 through cable 116. A general purpose input/output port may also be used for connection to a motion sensor device 119 through cable 120, e.g., to detect when someone enters the room containing the valuable A/V equipment.

Device 100 includes a port for connection to a network. For instance, device 100 may include an Ethernet port with an RJ-45 connector coupled to connection line 101 for access to network 102. Network 102 may comprise a TCP/IP network over land lines, for instance. Other connections from device 100 to the network may include wireless communication systems such as terrestrial, satellite, cellular, infrared, etc.

An operator may monitor and/or control any of the equipment connected to device 100 by using web access station 104, e.g., a computer station, which is connected to the network 102 via communication line 103. Again, communication line 103 may include any desirable communication method, for example, landlines and/or wireless.

In this illustration, an authorized user may log onto web access station 104 to view, from anywhere in the world, one or more pieces of equipment connected to device 100. Web access station 104 may be any interface device (such as a laptop, workstation, PDA, cellular phone, etc.) equipped with a web browser and a connection to network 102.

In one embodiment, the authorized user enters an object identification number, typically an IP Address, for the specific device 100 through which monitoring is desired. The web browser sends an HTTP get request, for example, to the specified device 100, and that device 100 sends its home page (e.g., in HTML format) to the user's web browser for display. Device 100 may send a pre-formatted web page, or, in other embodiments, device 100 may generate a web page by, for example, organizing suitable HTML tags and parameters into an HTML file that is sent to the user's web browser at web access station 104. Multiple users may access and control device 100 simultaneously through different web browsers.

In one example application, the apparatus of FIG. 1 may be configured to automatically enable and power-up A/V equipment when someone enters the room. For instance, when a user enters a room with motion sensor 119, motion sensor 119 detects the motion and sends the motion information to device 100 through connection 120. Device 100 is user programmable such that upon sensing the motion, Device 100 enables projector 117, lighting system 111, and display screen 112 for a specific amount of time. Another embodiment may engage a camera connected to one of the output ports of device 100, which can record the activity causing the motion disturbance on one of recording devices 107, 108, and 109. The apparatus may also be setup to alert another person of the disturbance and allow that other person to view the recorded information from anywhere in the world using a web browser. This may be accomplished, for instance, by recording the disturbance in a digital media connected to one of the available serial ports and to the network, and sending an e-mail notification to the appropriate entity.

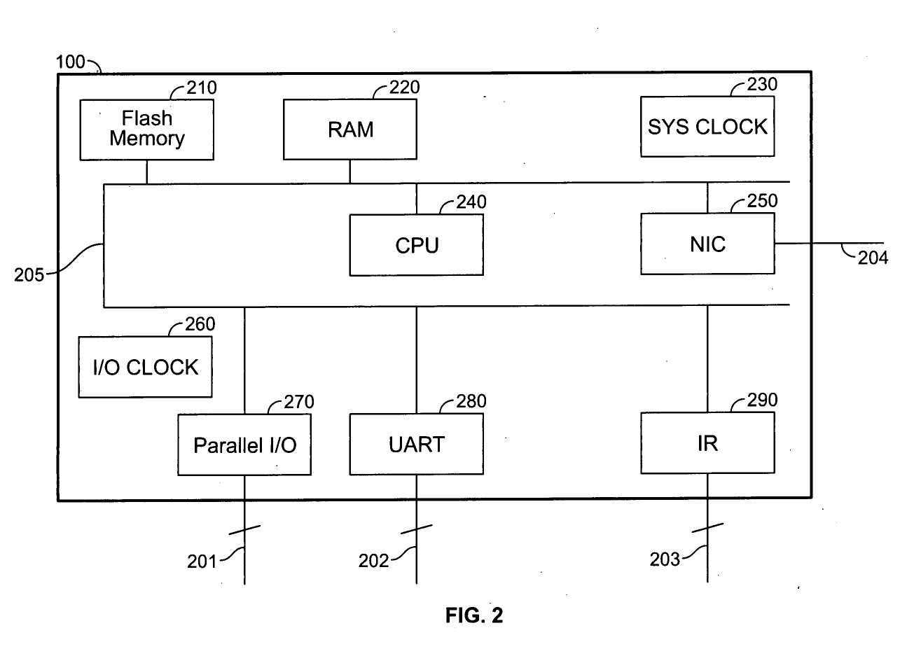

FIG. 2 is a top level block diagram of the web-serving device 100 in accordance with an embodiment of the present invention. In this illustration, web-serving device 100 includes Central Processing Unit (CPU) 240 as the main system processor communicating to all the internal functions through system bus 205. Device 100 further comprises non-volatile memory such as Flash Memory 210 for storage of system software, e.g., device drivers and other software requiring storage in non-volatile memory. Device 100 may also include volatile memory such as RAM 220 for processing. System clock 230 may include an internal oscillator for providing all the clocks required for operation of device 100. System clock 230 may also provide a real-time clock function. The real-time clock may be programmable to provide operating alerts, sequencing, and automatic monitoring. For instance, a real-time clock with a calendar may provide the capability to routinely check the status of the electronic equipment connected to device 100.

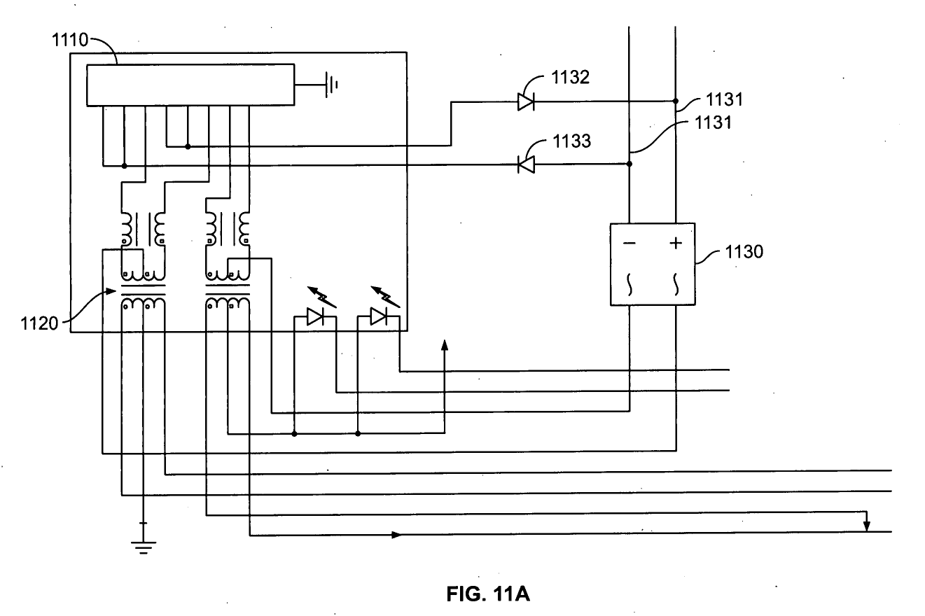

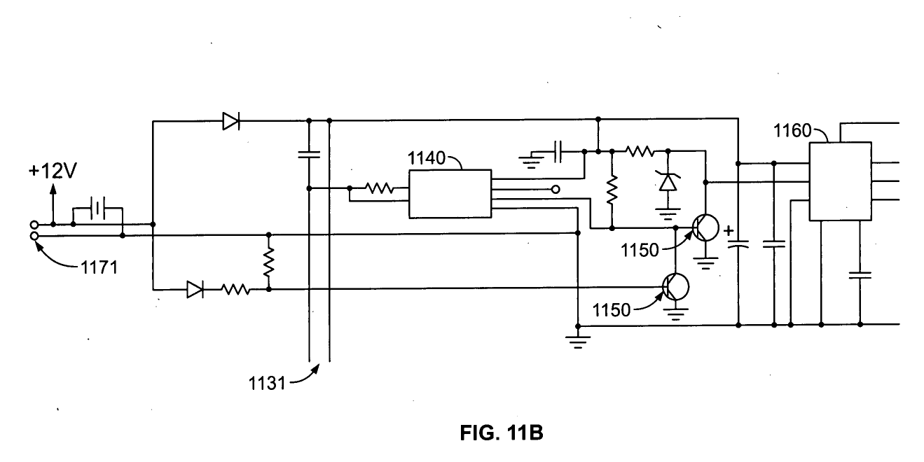

Device 100 may be equipped to receive power from the LAN in accordance with IEEE 802.3af, from a local power supply, or a combination of both LAN power and local power. The IEEE 802.3af standard has two basic modes for power over Ethernet. One mode is the Mid-Span mode where the extra pair in a 100 Mbps cabling to send 48 Volts down the line. The other mode is the End-Cable mode where 48 Volts is sent down the same line as data signals, which are AC-Coupled. FIGS. 11(A and B) is an illustration of a power scheme in accordance with embodiments of the present invention.

In this illustration, an embodiment of device 100 is connected to an Ethernet network via connector 1110, which may be an Rj-45 type connector. In the end-cable mode, the signal lines are passed through isolation elements 1120, e.g., transformers and also through bridge rectifier 1130 to provide 48 Volt DC at lines 1131. Alternately, the invention may receive power in the Mid-Span mode from the extra two pins of the 100 Mbps cabling through diodes 1132 and 1133 to provide 48 Volts DC at lines 1131. The network may be protected by forward biased diodes that prevent any power feedback to the network.

The power from lines 1131 feeds to signature detector 1140. Signature resistor 1140 provides signature resistance such that power is provided to device 100 when upon detection of the proper power signature. This also provides for backward compatibility with networks without IEEE 802.3af compatible power. Thus, device 100 will not turn on if the proper power signature is not detected on the network lines by detector 1140.

When detector 1140 detects the proper power signature, it turns on switching transistors 1150, which turn on regulator 1160. Regulator 1160 provides the necessary power, e.g. +5 volts, to run powered components of device 100.

Power to device 100 may also be provided using independent power supply into pins 1171. In this illustration, a +12V supply is provided at pins 1171 to alternatively power device 100. When power is provided through pins 1171, the state of transistors 1150 determines from which power source device 100 is powered. Thus, an embodiment may provide use of an independent power source when proper network power is unavailable.

Referring back to FIG. 2, Device 100 may be implemented as a scalable server with various types of configurable input/output ports. For instance, device 100 may include parallel I/O controller 270 for connection to external electronic devices through flexible port 201; serial interface controller UART 280 for communication through port 202 with external devices having serial communication capability; infrared output controller IR 290 for communication with external devices with IR capability through port 203; and network interface controller NIC 250 for communication with an IP network, such as the Internet, via port 204. I/O Clock 260 may provide any necessary clock signals to drive the I/O controllers in accordance with any required standards.

Serial Input/Output

In one or more embodiments, Serial port 202 provides bi-directional communication with external devices. Serial port 202 may comprise one or more nine-pin D-sub serial ports and/or captive screw terminal serial ports for flexible connectivity to a variety of equipment. A nine-pin D-sub serial port offers RS-232, RS-422 and RS-485 compatibility, while a captive screw terminal typically supports RS-232 communication. Serial port 202 may be configured for various modes. For instance, port 202 may be configured for a “pass-through” mode that provides the capability to pass through commands from an existing control system and to control and monitor a connected device. For instance, device 100 may connect to an A/V system through one or more of the serial ports for monitoring and control while maintaining the ability to use a local control system (e.g., remote control).

In one or more embodiments, configuration of serial port 202 is configurable through control of transceiver UART 280. The transceiver could be a device such as the SP3232E, SP522, S50x series, etc, from Sipex Corporation; the MAX232, MAX483, etc, from Maxim; and other suitable Transceiver devices. A suitable transceiver may be one that is programmable to accommodate several protocols thus allowing for configurability through a web browser. Note that other suitable transceivers may be configurable through jumpers and/or software.

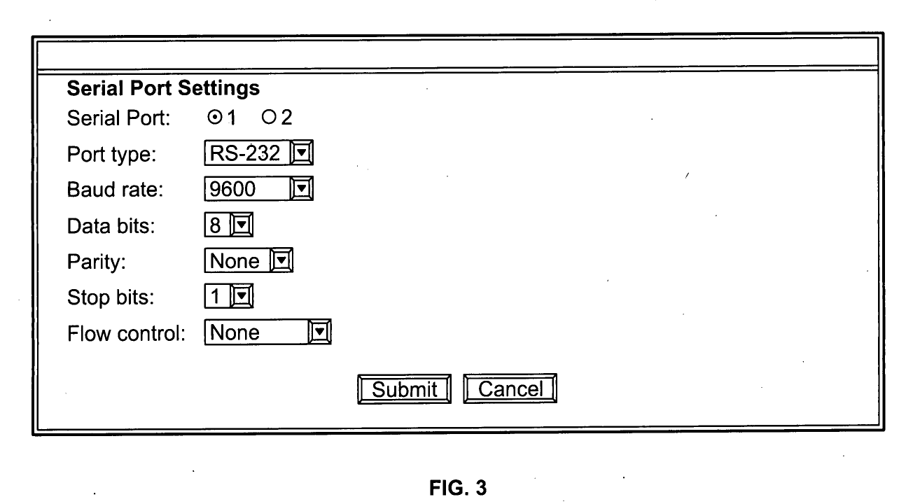

FIG. 3 is an illustration of a graphical user interface for configuring the serial port transceiver. The graphical user interface may be presented as a forms-based web page. When a user selects a given parameter value from the web page (e.g., baud rate of 9600 bps), the web browser at the web access station transmits this parameter value back to device 100 (e.g., using URL encoding) where a control register for the serial port transceiver is set accordingly. In this illustration, the graphical user interface provides for selection of port type (e.g. RS-232, RS-422, and RS-485), baud rate, number of data bits, parity (even/odd), number of stop bits, and flow control (XON/XOFF).

Port Contention Resolution

Within embodiments of the invention, multiple identified services (i.e., telnet, web, direct access, pass-through, event scripts, etc.) running within CPU 240 may need to use a specific serial port for communication. One or more embodiments of the invention may implement a contention management method, as described below, to obviate any potential port contention problems resulting from a single bi-directional communication port being shared among multiple services.

The contention management method of the present invention handles simultaneous requests for an individual serial port. In one or more embodiments, contention may be handled in real time by a contention manager process executing within CPU240. For example, the contention manager may be part of a real-time operating system within device 100.

According to one or more embodiments, each service may specify one or more parameters that tell the contention manager how to deal with the outgoing and return data on the serial port(s). Those parameters may include, for example, timing information, expected length of response data, and the response terminating character or delimiter value. The expected length of the response data and the response terminating character may be omitted, for example, in systems that rely on timeouts to determine port control.

The format for delivering parameter information may vary among different embodiments. As one example, a control service (e.g., telnet, web, or event scripting) can use the following command format to define for the contention manager how a control port will be used.

<esc>{port #}*{initial character timeout}*{per character timeout}*{Length or Delimiter}RS<cr>{outgoing data}

Where:

<esc> Escape character (0×1Bh), or other predetermined symbol.

{port #} Port number to use—range 00-99; ASCII representation of the value

* Asterisk (shift-8) (0×2Ch)

{initial character Time value for the service to wait until the first character is timeout} received; ASCII representation of the value may be in 10 millisecond increments, for example, with a default of 10 (100 milliseconds)

{per character Time value for the service to wait after each additional timeout} character is received; ASCII representation of the value is in 10 millisecond increments, for example, with a default of 2 (20 milliseconds)

{Length or Length represents the total number of character to wait for Delimiter} before releasing the serial port. Delimiter represents a single byte that when received will release the serial port. Only one of these can be used at a time and they are both ASCII representation of the parameter value.

RS Command mnemonic recognized by the contention manager

<cr> Carriage return character (0×0Dh). Alternately use|(pipe symbol) or other predetermined symbol

{outgoing data} Any ASCII data; for example, all data may be transmitted following the <cr> before the {initial character timeout} has expired.

### EXAMPLE #1

<esc>01*10*5*13DRS|Hello?

This command will send the data “Hello?” out serial port 1 and wait up to 100 milliseconds for the first character of the response to come in. If the response starts within 100 milliseconds, then each additional byte must come in within 50 milliseconds or the service will release the serial port back to the contention manager. Each byte coming in is checked to see if it matches the specified delimiter, in this case a carriage return (0×0Dh=13 decimal), and if it does, the service will cancel the timing criteria and then release the serial port back to the contention manager.

### EXAMPLE #2

<esc>6*50*10*24LRS|STATUS REQUEST

This command will send the data “STATUS REQUEST” out serial port 6 and wait up to 0.5 seconds for the first character of the response to come in. If the response starts within 0.5 seconds, then each additional byte must come in within 100 milliseconds or the service will release the serial port back to the contention manager. A count of the number of bytes received is kept by the contention manager, and if the number of bytes matches the specified value, in this case 24 bytes, the service will cancel the timing criteria and then release the serial port back to the contention manager.

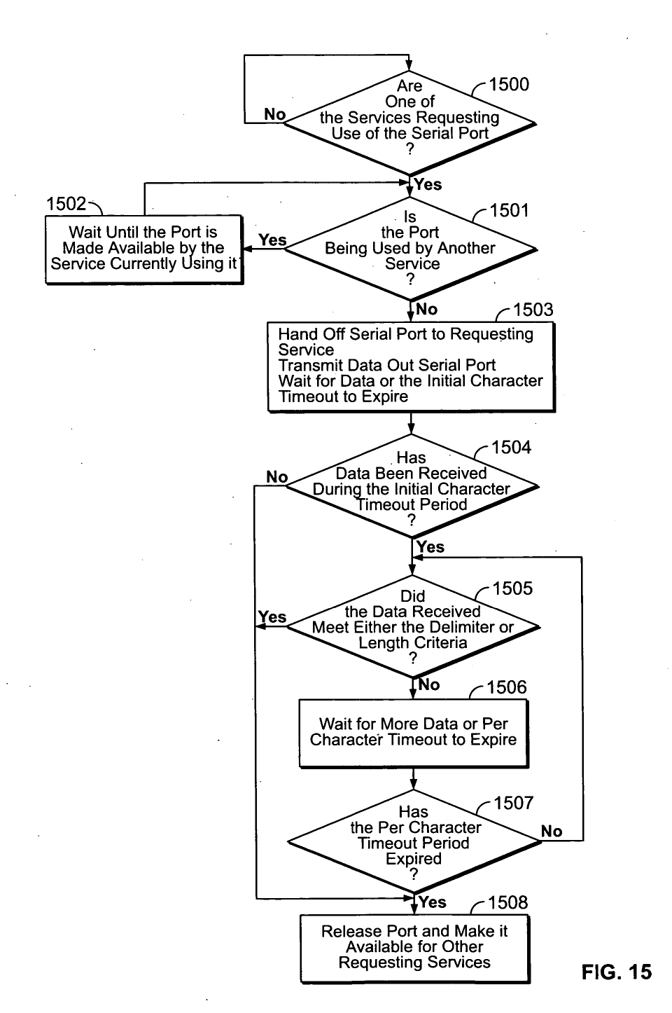

FIG. 15 is a flow diagram illustrating an embodiment of a contention management process, in accordance with one or more embodiments of the invention. In block 1500, the contention manager determines whether one of the multiple possible services (e.g., telnet, web, direct access, pass-through, event scripts, etc.) executing within device 100 is requesting use of a serial port. If none of those services is currently requesting use of the serial port, then the contention manager continues waiting for such a request at block 1500. However, if one of those services is requesting use of the serial port, then, in block 1501, the content manager determines whether the serial port is currently being used by another service. If the port is currently in use, the requesting service must wait until the port is made available by the service currently using it (block1502).

It is possible for more than one service to be waiting to use the serial port. In such cases, the serial port may be grabbed by the first service to request use of the port after the prior service releases it. It is also possible for the service requests to be placed in a queue for processing in a FIFO (first in, first out) manner. Alternatively, or in addition, the services (and/or specific request types) may be assigned a priority value, such that more time-critical services or requests will be processed earlier than less critical services or requests.

When the serial port is not in use by another service (i.e., the port was idle or a service just released it), in block 1503, the contention manager resets the “initial character” timeout timer, hands off the serial port to the requesting service, transmits the request data out of the serial port, and waits for incoming data or for the “initial character” timeout to expire. In block 1504, the contention manager determines whether response data has been received during the “initial character” timeout period. If no data was received during the “initial character” timeout period, then the contention manager releases the serial port in block 1508, and makes the serial port available to other services.

If, at step 1504, data was received during the “initial character” timeout period, then, in block 1505, the contention manager determines whether the received data represents the end of the response, either by meeting the “expected length” criteria or by matching the “end of response” delimiter criteria. If the received data does represent the end of the response for either of those two reasons, then the contention manager releases the serial port to other waiting services in step 1508.

However, if, in block 1505, the received data does not represent the end of the response, then, in block 1506, the content manager resets the “per character” timeout timer and waits to receive more data, or for the “per character” timeout to expire. If, in block 1507, response data is received prior to expiration of the “per character” timeout, the content manager returns to block 1505 to see if the received data meets either of the “end of response” criteria. However, in block 1507, if the “per character” timeout has expired, then the content manager releases the serial port to other requesting services in block 1508. Following the above method, multiple services can request the use of the serial port and the contention manager can handle contention resolution and ensure that the data requested is delivered back to the correct service.

The contention manager is useful for applications using the “pass-through” capability of some embodiments of the invention. A pass-through service is used to define a bi-directional data path between two serial ports allowing embodiments of the invention to be inserted between an existing controller and the controlled device without re-programming the existing controller.

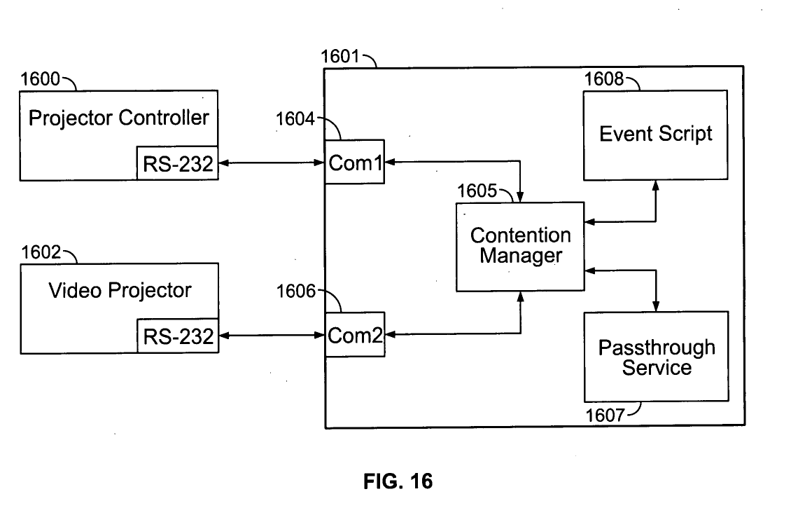

FIG. 16 is a block diagram illustrating an example application of the contention manager. FIG. 16 depicts a controller (projector controller 1600) communicating to an RS-232 controlled device (video projector 1602) by passing its control commands through a device 1601 that embodies the present invention. In addition to providing pass-through service 1607 to enable the transmission of commands from projector controller 1600 to video projector 1602, device 1601 also executes event script 1608, which is monitoring the video projector's status.

In order to ensure that the commands from projector controller 1600 are sent to video projector 1602 and the corresponding responses are received by projector controller 1600 from video projector 1602, contention manager 1605 mediates the contention between the event script 1608 and projector controller 1600 on COM1 (serial port 1604).

By setting up a pass-through condition from COM1 (serial port 1604) to COM2 (serial port 1606), data to and from video projector 1602 is routed to projector controller 1600. The pass-through condition is created by a pass-through request issued from a service (herein referred to as a pass-through service, though conceivably any service may issue such a request in some embodiments) to the contention manager. One possible request format for setting up a pass-through condition is as follows:

<esc>{port #A}*{port #B}*{per character timeout}*{Length or Delimiter}CD<cr>

This command takes similar parameters as the previous one but has a different predetermined command mnemonic (e.g., “CD”).

When command data is transmitted from projector controller 1600 to COM1, the data may be buffered temporarily, and an associated service (e.g., pass-through service 1607) is notified of the presence of the buffered command data. Pass-through service 1607 sends a pass-through request (e.g., in the format shown above) to contention manager 1605, requesting a pass-through connection between COM1 and COM2. If event script 1608 currently controls COM2, then pass-through service 1607 must wait until contention manager 1605 regains control of COM2 (e.g., through the contention management process described in FIG. 15). Otherwise, contention manager 1605 gives pass-through service 1607 control of COM2 and COM1 to enable the buffered command data to pass through to projector 1602, and to enable any command response data to be transmitted from projector 1602 to projector controller 1600, subject to the specified timeout, length and/or delimiter parameters of the pass-through request.

Though the above port contention issues are described with reference to serial ports, a contention manager may also be used to resolve contention for other types of communication ports (e.g., parallel, IR, etc.) or combinations of such ports. The contention manager may also be extended to resolve contention issues associated with other resources accessed by multiple services. Like wise, the “pass-through” configurability described above may be extended to other communication port types and combinations.

Flexible I/O Ports

In one or more embodiments, device 100 may be configured with one or more Flex I/O ports 201. Each flexible port can be configured as analog in, digital in or digital out. Each port may also be configured to support a large range of signal magnitude. For instance, a flexible I/O port capable of supporting digital and analog signals from 0 to 24 volts provides a voltage range suitable for controlling and/or monitoring a wide variety of equipment.

The ports can be configured to receive analog voltages from devices such as photo sensors, level feedback devices, strain gauges, thermocouples and variable potentiometers. In one embodiment, any incoming voltage signal is sampled with a high resolution analog-to-digital converter. The digitized voltage is then provided to processing unit 240 for further action (e.g., to be stored in an internal register for comparison or transmission as necessary for the specific application). For example, a voltage threshold may be set and when the threshold is past, device 100 may be configured to send out a serial command or e-mail message, or to trigger another event. In another example, a thermal sensor installed in an equipment rack may be connected to one of the Flex I/O ports 201. Device 100 may be configured to turn on auxiliary cooling fans and/or send an e-mail if the rack temperature exceeds a specific temperature. The trigger temperature may be implemented as a register value configured via forms in a web page provided by device 100.

When configured as digital inputs, Flex I/O ports 201 may connect to switches, sensors (e.g., moisture, motion, etc.), and other similar digital devices to provide feedback to device 100. This configuration may provide the ability to receive status from a variety of devices such as projector lifts, motorized projection screens, room partition switches, and push buttons.

When configured as digital outputs, Flex I/O ports 201 may drive LEDs, incandescent lamps, and other devices. For example, applications that require contact closure control may interface, with Flex I/O ports 201 through a relay box. Thus in operation, Flex I/O ports 201 may energize a relay to provide loop closure.

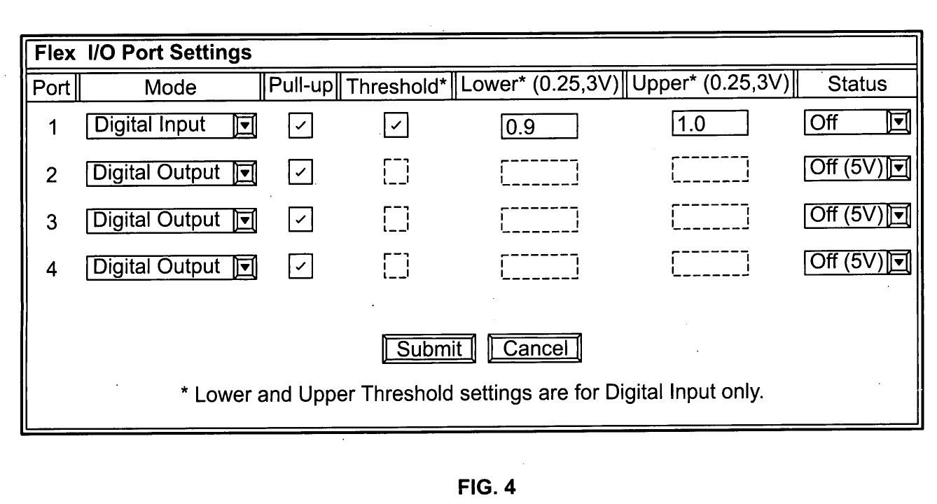

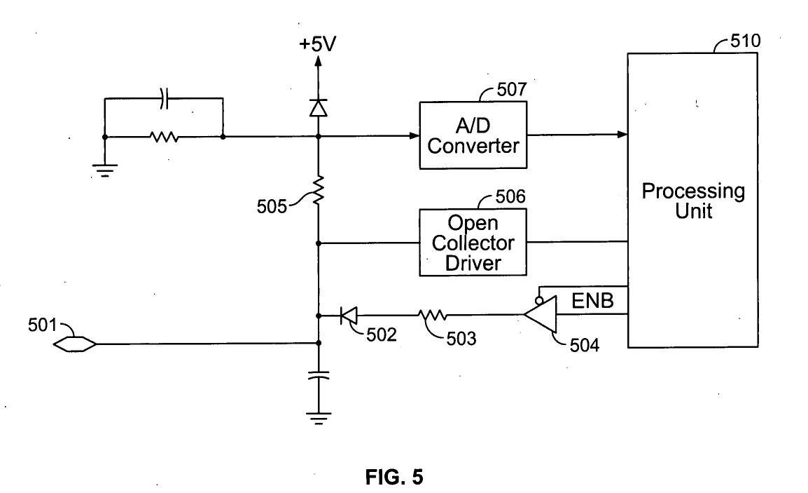

FIG. 5 is a circuit schematic illustrating the configurability of the Flex I/O ports in accordance with one embodiment of the invention. When configuring port 501 as a digital output port, the user may set configuration parameters using the browser interface as shown in FIG. 4, for example. Those configuration parameters set appropriate registers in Processing Unit 510, which can then be used to drive, directly or indirectly, switches or gates enabling specific circuitry for the specified configuration. Processing Unit 510 could be a device such as an FPGA (Field Programmable Gate Array), a microcontroller, or other similar device.

Configuring port 501 to digital output mode involves the Processing Unit 510 enabling programmable pull-up resistor 503 and diode 502. To generate output high, the Processing Unit enables the signal line to tri-state buffer 504 thereby removing the buffer out of tri-state mode and driving pull-up resistor 503 high. To generate the output low, an open collector output driver 506 is set to low impedance mode by Processing Unit. Note that driver 506 is an open collector output device that pulls to ground with very low impedance. The characteristic of open collector output driver 506 is that its output goes to high impedance when off thus behaving as an unconnected device. Open collector output driver 506 may be implemented with a device such as ULN2003A from STMicroelectronics.

Configuring port 501 to input mode, analog or digital, involves the Processing Unit setting open collector output driver 506 to high impedance state (i.e. off), and setting tri-state buffer 504 to the off mode. Thus, the primary impedance between input port 501 and analog-to-digital (A/D) converter 507 is the voltage divider formed by resistors 500 and 505. This voltage divider scales the input voltage to an appropriate value for A/D converter 507.

FIG. 5 illustrates one possible embodiment of circuitry for providing configurable Flex I/O ports. It will be understood that other circuitry configurations may be used to provide an equivalent configurable I/O port within the scope of the invention.

Infrared Ports

Embodiments of Device 100 may include one or more fully programmable IR ports. Each IR port may be capable of outputting IR signals with or without the carrier signal using a wired IR emitter or through an IR broadcaster. Device 100 is capable of collecting IR control data in various ways such as file download and IR learning. IR data may be downloaded from a variety of sources for a variety of devices for storage in device 100.

IR data, such as timing information, may be stored in First-In-First-Out (FIFO) buffers in Processing Unit 510. A state machine in Processing Unit 510 may then cycle through the buffer to generate a modulated signal. The modulated signal may be clocked the I/O Clock 260 (FIG. 2). I/O clock 260 may be a device such as a Sixty Six (66) MHz master clock crystal thereby providing for generation of multiple carrier frequencies using clock divider. Thus, it is possible to provide IR control for a variety of equipments with the present invention.

Also stored in Processing Unit 510 is the number of cycles of a carrier frequency to put out in bursts to the equipment under control. The output signals may then be passed through transistors (e.g. FET) to drive cables having IR emitters.

Device 100 may also include the ability to learn IR commands for virtually any IR controllable device. A simple and easy IR learning process may be implemented using an IR remote provided with a device. Embodiments of the invention may also associate specific serial command strings with specific IR commands. The IR learning capability allows a multitude of devices with legacy interfaces to be easily adapted to today's high-speed LAN communication systems.

Network Interface

Embodiments of Device 100 use industry standard Ethernet communication protocols, such as ARP, DHCP, ICMP (ping) TCP/IP, Telnet, HTTP, and SMTP to provide a web interface to a user for monitoring, controlling and scheduling of equipment connected to device 100. Embodiments of device 100 provide the capability to write and upload scripts that automate some functions. For example, the user may want to control some electronic equipment based on assignable criteria such as turning connected equipment on or off at predetermined times and alerting individuals if an attached unit is stolen or goes offline.

Multiple users may simultaneously connect to device 100 enabling support of many concurrent users. Device 100 improves system throughput by sending information to all the users in parallel. Further, because device 100 can be used to monitor and control multiple pieces of equipment simultaneously, configuration and monitoring are simplified, and less network traffic is created than would be the case for a system in which each piece of equipment is required to be monitored and controlled separately.

Various levels of security with password protection may be included in some embodiments of the invention. For instance, a “User” access level may authorize limited entry to only pre-designated functions, while an “Administrator” access level permits full access to advanced settings.

Device 100 includes a Generalized Graphical User Interface, which serves as an asset management tool by allowing the user to identify and monitor all electronic equipment connected to each of one or more web-serving devices 100 in the system. The user can configure the web-serving devices 100 for control of the equipment through the Generalized Graphical User Interface interface.

Users can implement driver packages containing all data and control functionality for a specific piece of equipment or create their own drivers. Once the pieces of equipment are identified and configured, the user can view the status of all equipment via a web browser. Each Ethernet-enabled device 100 will have a unique IP address with links tied through the Generalized Graphical User Interface device list. The user simply clicks on an icon representing the chosen device in the system. To assist in the configuration process, the Generalized Graphical User Interface may contain context sensitive help, which provides information specific to the page being configured.

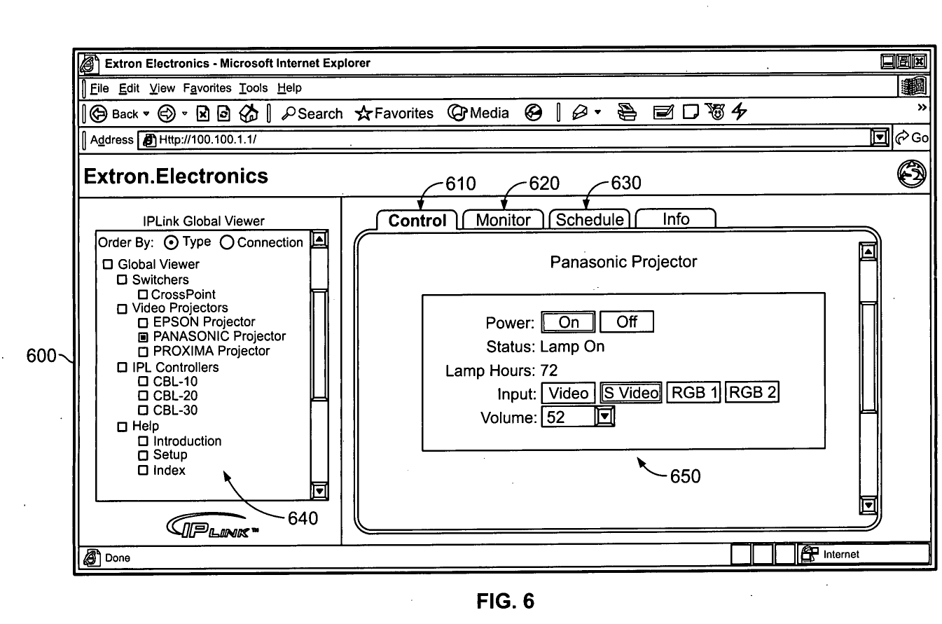

FIG. 6 is an illustration of an example Generalized Graphical User Interface in accordance with an embodiment of the present invention. In this illustration, Generalized Graphical User Interface 600 has various tabs that enable a user to access, control (e.g., tab 610), monitor (e.g., tab 620), and schedule (e.g., tab 630) electronic equipment (e.g., A/V products) connected to device 100.

Generalized Graphical User Interface 600 may be customized to provide a centralized management center for all equipment connected to various web-serving devices 100 in an environment such as a school, or all around the world. In such a case, window 640 may provide a tree-type selection approach for each device 100 and its connected electronic equipment. Window 650 provides a customizable web page that may be tailored to meet specific needs and provide the desired functionality for each piece of equipment. Each web page 650 may be dynamically created using “server-side include” functionality. The “server-side include” function parses HTML command lines and includes the desired information in the web page sent to browser 600. The “server-side include” function is described in detail in the next section (“Configuring Device Web Pages”).

The Generalized Graphical User Interface and the Ethernet-to-serial interface capability of the present invention provide a necessary functionality for asset management. With its polling and e-mail capabilities, which allows a user to program device 100 to continually monitor the status of one or more other devices connected to it and provide notification to a user (e.g., via e-mail) when a certain condition is met, device 100 can quickly alert users to security breaches. Also, by having access to all network-connected equipment, users can determine which devices are used most frequently and allocate resources based on need.

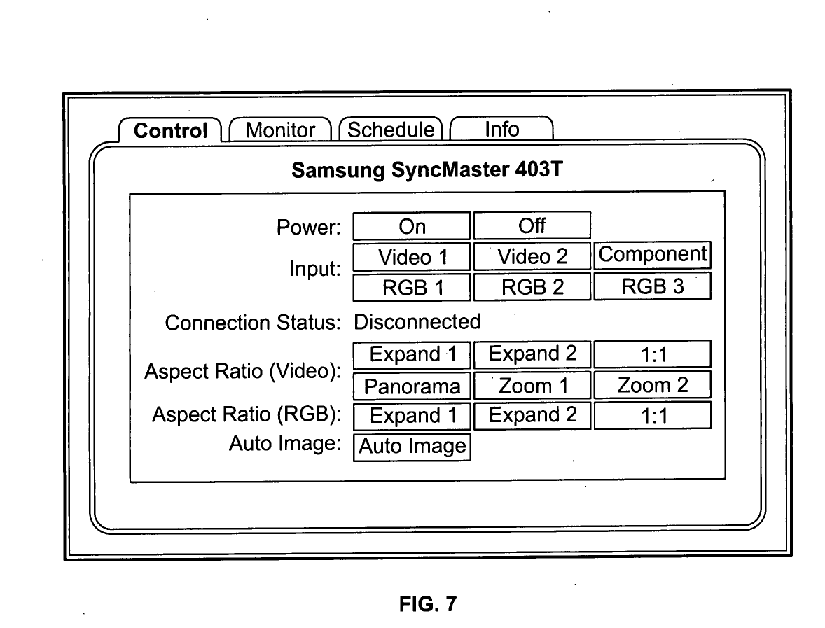

To allow for the individual needs of each environment, the software interface can be customized to display equipment status in any number of ways. For instance, color-coded buttons may signal power on or off, or bar graphs may show maximum amount of lamp hours vs. hours used. Users can also create their own look and feel by including a logo or marketing message using HTML, Flash animation, JavaScript, and more. FIG. 7 is an example web page that may be created for control of a Samsung™ LCD monitor.

In this illustration, a user is able to select functions such as power on/off, video input source selection, and resizing of the viewing area.

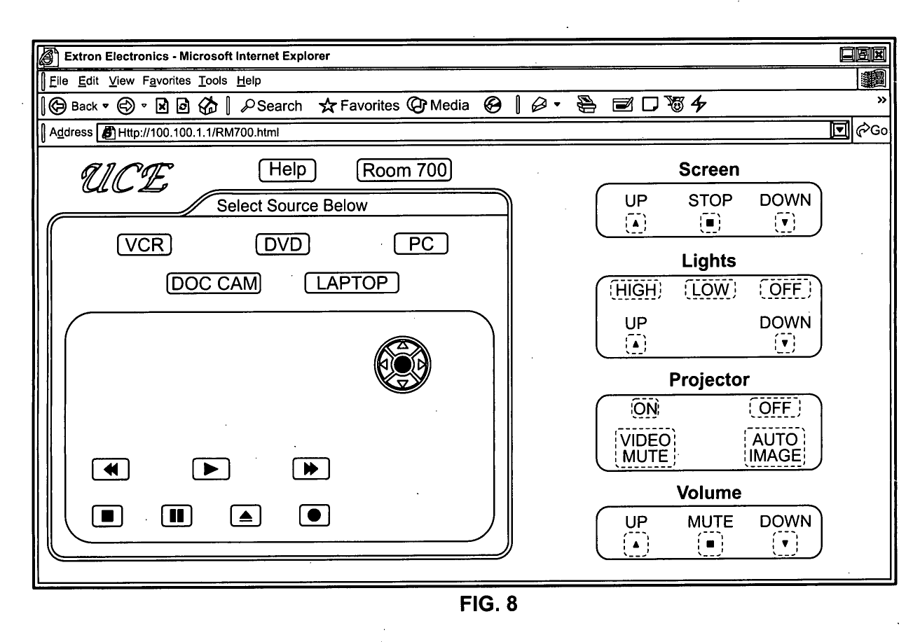

FIG. 8 provides another illustration of a web page associated with control tab 610. A user is provided with the ability to view and manipulate such basic functions as volume, mute, video inputs, power, and other functions of A/V equipment (e.g., a projector). In this illustration, a user can remotely control equipment such as a VCR, DVD, PC, Document Camera, laptop, etc., using the control buttons provided on the web page. For instance, there are buttons for “Play”, “Fast Forward”, “Rewind”, “Pause”, “Stop”, etc. The basic control system (e.g., remote control) of each piece of equipment remains functional while a user is provided the added functionality of controlling all of the equipment from anywhere in the world.

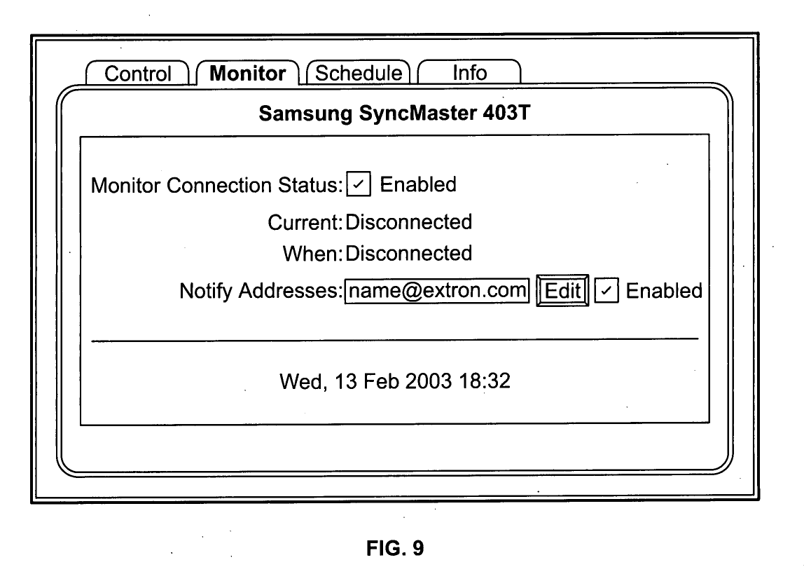

A monitor web page provides a user the ability to view status functions of a product. For example, a user can poll the lamp hours of all connected projectors, even if the projector does not have a built-in lamp timer. With projectors and other devices without a built-in timer, device 100 may monitor the ON and OFF times by either controlling the power switch or sensing the change in current, for example. The device may also be programmed to notify a user by e-mail. For example, FIG. 9 is an illustration of a monitor web page for the Samsung™ SyncMaster monitor. In this illustration, device 10 is configured to notify the user by e-mail when the equipment is disconnected.

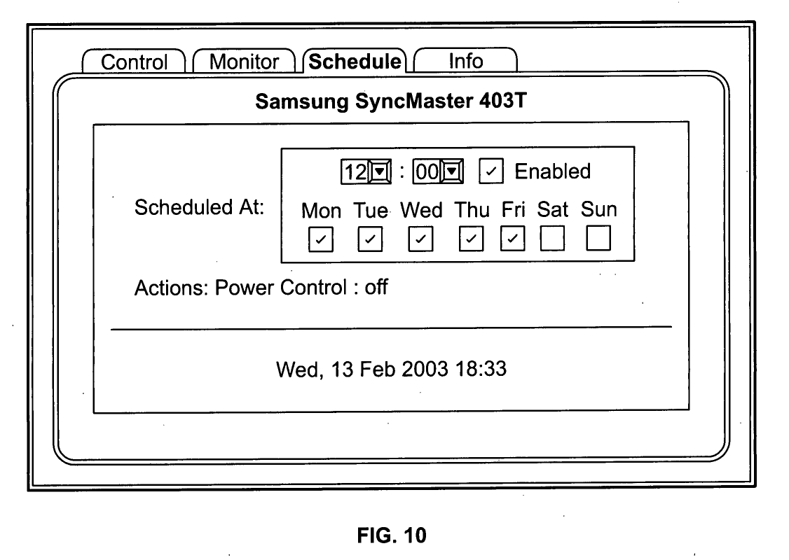

In another example, a scheduling web page (e.g., associated with the schedule tab of the Generalized Graphical User Interface) may provide the ability to control devices over time. For instance, FIG. 10 is an illustration of a scheduling web page for the example Samsung™ SyncMaster monitor. In this illustration, the monitor is scheduled to power off Monday through Friday at 12:00 noon. This information may be passed to device 100 where it may be stored in registers or other memory associated with monitoring the specified piece of equipment.

In a typical application, a technician at an educational facility with several classrooms may need access to control, monitor, and troubleshoot the school's A/V equipment from a single location on campus. Using the Generalized Graphical User Interface software, the technician can program one or more web-serving devices (100) to track the projector lamp hours in each classroom and generate an e-mail alert at 1,350 hours, well before each projector lamp's expected life maximum of 1,500 hours. The technician may set up the device so that alerts can be received by e-mail via a computer, cell phone, PDA, or pager. With timely information regarding lamp life, the technician can then order and replace the lamps before the existing ones burn out. In addition, the technician can configure the projectors to power on or off at pre-selected times, and each device can be automatically monitored for its connection to the LAN. Thus, the present invention helps minimize downtime because equipment may be proactively serviced.

Configuring Device Web Pages

Each device web page may be configured dynamically. A user may program device 100 to dynamically obtain device and/or equipment status when a web page is requested by a web browser. Requests from the web browser may be sent to device 100 via URL encoding or other transfer mechanism. Upon receiving the request, device 100 parses the request to determine what information is requested, or what action to take.

For instance, a user may want to reset the counter for Lamphours for a particular projector connected to device 100. The user may send the command to reset the counter by pressing a button on the browser that says “Reset Lamphours”, for example. The browser sends the command “<IP-ADDRESS>/<Name_Page>?Lamphours=0”. Upon receiving the command, device 100 parses the command, obtains the variable “Lamphours” and the value of “0”, then sets the corresponding register value in memory to “0”.

Web pages may be built dynamically because information for each device may be obtained by the appropriate HTML command line. For instance, the following command will retrieve the desired information, using a “server-side include” function, and send the data back to the web page.

typeArray[1]=′<!—#echo var=“W1CY|”—>′;

Device 100 parses this HTML command line, retrieves information represented by “W1CY” and returns the web page with the retrieved information to the web browser.

Processing of and dynamic creation of web pages are very fast because, in one or more embodiments, device 100 uses a flattened network stack instead of the traditional seven layer. OSI (International Standards Organization) stack, when receiving network traffic. A flattened stack allows for faster processing of network traffic to determine if the information contained in the traffic is of interest to device 100. The flattened stack approach treats the data as one long piece of flattened data. By contrast, the seven layer model requires processing at various layers before the actual data is retrieved at the seventh layer (i.e. the Application Layer). A flattened stack allows one to immediately check the first one or two bytes of data to determine and obtain information of interest to device 100 without the added burden of processing in the previous six network layers.

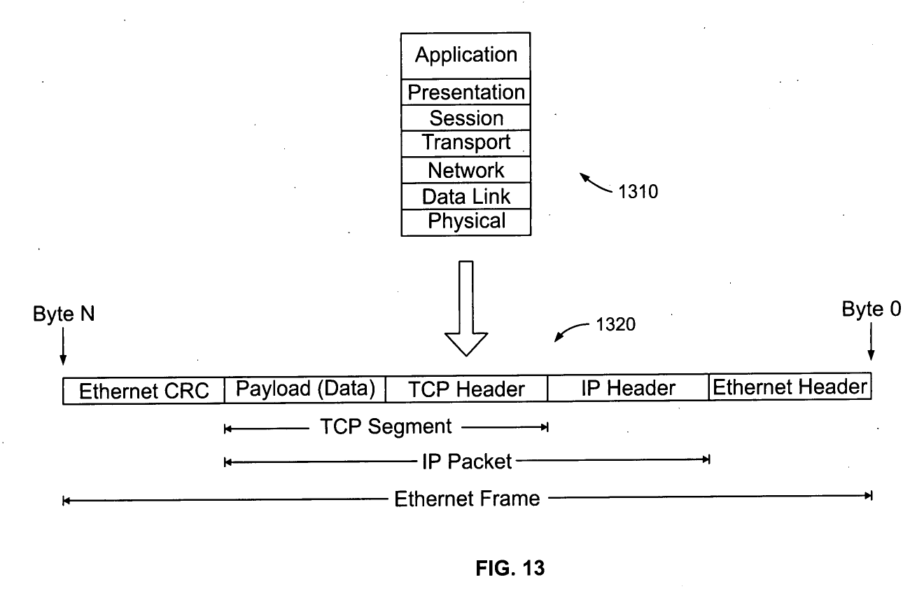

FIG. 13 is an illustration of the flattened stack in accordance with embodiments of the present invention. The flattened stack, which may be implemented in either hardware or software, arises from the need to eliminate redundant processing in device 100. The OSI seven layer model 1310 is replaced with a flattened stack 1320 for processing. The Ethernet packet arrives in the following segments (frames), from Byte 0 through Byte N, with the Ethernet Header; followed by the IP Header; followed by the TCP Header; the Payload (or Data); and finally the Ethernet CRC (Cyclic Redundancy Checking) frame.

Normally, prior art systems will receive the Ethernet packet and process the Ethernet frame, then process the IP packet, then process the TCP segment, before the packet is passed to the Application layer. The Application layer then checks if the application data is valid and needed. If the data is valid and needed, it will be processed, otherwise it will be dropped. Thus, needless processing is performed before the decision to drop unneeded data is made.

One or more embodiments of the present invention may avoid much of the needless processing that occurs before the drop decision is made in prior art systems. This is possible because the lowest layer of the OSI stack has knowledge of what applications are active in the upper layers. Thus a flattened stack allows the packet to be discarded at the earliest possible point so no processing power is wasted. The flattened stack implementation organizes its check/processing based on the raw data stream thus minimizing buffer requirements and providing for easier implementation into hardware.

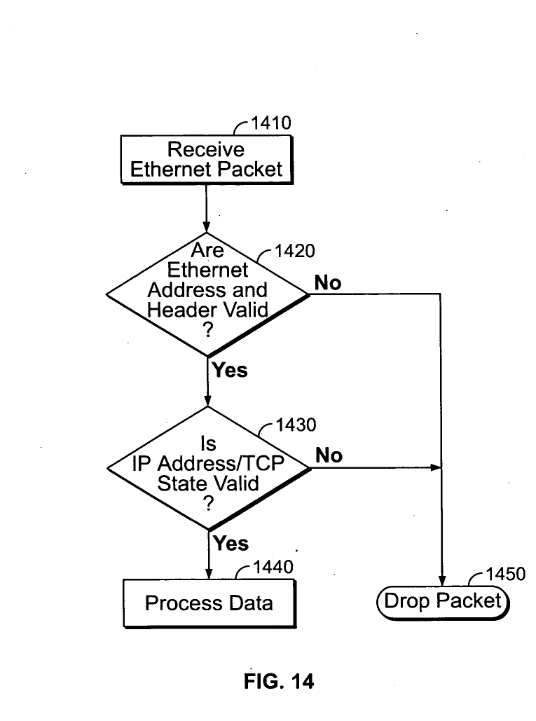

Embodiments of the present invention reduce the needless processing by making the drop/process decision immediately as illustrated in FIG. 14. The Ethernet packet is received in block 1410. At block 1420, the Ethernet Address and Header are checked for validity. If the Ethernet address and header are not valid, the packet is dropped immediately at Block 1450. Otherwise, if the IP address and header are valid processing proceeds to block 1430. At block 1430, the IP Address and TCP state are checked for validity. If the IP address and TCP state are not valid, the packet is dropped immediately at Block 1450. Otherwise, if the address and header are valid processing proceeds to block 1440 where the data is processed.

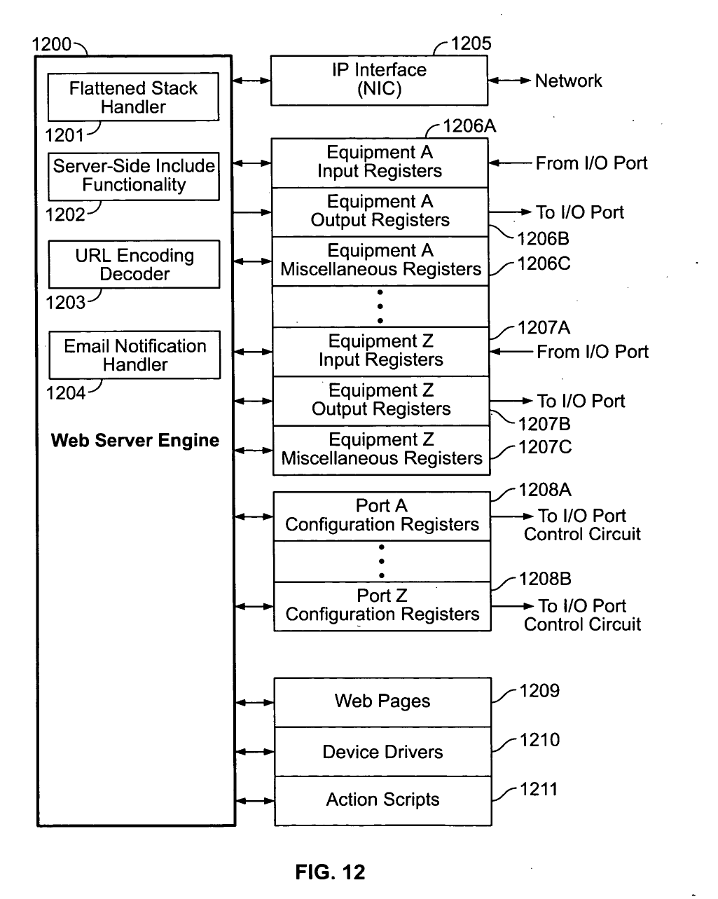

FIG. 12 is a block diagram illustrating, in accordance with an embodiment of the invention, a firmware/software configuration of a web server device that may be implemented using the CPU and memory hardware previously described. Web server engine 1200 may be implemented using software stored in memory and executed by a processor, firmware stored in ROM (or EPROM or any other ROM-variant circuit), logic implemented with application specific circuits, logic implemented in a programmable circuit such as a field-programmable gate array (FPGA), or any combination of the foregoing. Registers 1206A-1206C, 1207A-1207C and 1208A-1208B may be implemented as memory locations in RAM or as register locations in a processing unit (e.g., a microprocessor). Blocks 1209-1211 may be implemented with RAM, though default web pages, drivers and action scripts may also be stored in ROM. IP interface 1205 is implemented by the circuitry used to provide communication with the IP network (including wired or wireless support).

Web server engine 1200 comprises flattened stack handler 1201, “server-side include” functionality 1202, URL encoding decoder 1203, e-mail notification handler 1204, active services 1212 and contention manager 1213. Flattened stack handler 1201 provides the mechanism for inserting and extracting application level information into transmitted IP packets and out of received IP packets. The use of a flattened stack allows the web server engine to respond to web service requests much faster than conventional web servers.

“Server-side include” functionality 1202 implements the generation of web pages for transmission to a requesting web browser. This web page generation may be achieved through the insertion of HTML (or related hyper-text language) information into an HTML file (e.g., a web page from storage block 1209) using “server-side include” command structures, as described previously.

URL encoding decoder 1203 extracts commands and data inputs from received http requests, and initiates execution of the given command or writes the extracted data value to the identified register. URL encoding is described in more detail in a previous section of this specification.

E-mail notification handler 1204 responds to scripted or otherwise scheduled monitoring tasks to construct and send an e-mail message to specified e-mail addresses when a specific event occurs or a designated time interval elapses. The email addresses may be stored, for example, within registers associated with a given piece of equipment (e.g., miscellaneous equipment registers 1206C and 1207C), or in general registers associated with the web-serving device itself (not shown). The email notification may be sent over the IP network, or it may be transmitted over another output port of the web-serving device, such as a serial port.

Active services 1212 are those services activated for specific applications. Those services may be activated, for example, by web-based configuration of the web-server device itself. Such services may include, for example, telnet services, web services, direct access services, pass-through services, script execution services, etc. Contention Manager 1213 provides real-time mediation between multiple services requesting control of the same communication ports.

Equipment A input registers 1206A and equipment Z input registers 1207A may be used to store the input received from an I/O port associated with the given piece of equipment being monitored and controlled by the web-serving device (note that the equipment could be another web-serving device). Such input may be digital input representing the status of a piece of equipment (e.g., lamp is “on” or “off”), or it may be the digitized input received from the analog-to-digital converter of a flexible I/O port configured for analog input. Web server engine 1200 may read the input register as directed by, for example, a corresponding action script or device driver.

Equipment A output registers 1206B and Equipment Z output registers 1207B may be used to store digital data to be transmitted over one of the output ports. Such output data may include, for example, control and configuration data associated with the performance of an attached piece of equipment. Web server engine may overwrite the stored output data as directed by an action script or commands received via URL encoding in an HTTP request. Further, the transmission of the output data through the output port may be performed in accordance with a device driver stored in memory block 1210.

Miscellaneous registers 1206C and 1207C may be used to store data values associated with the monitoring and control of corresponding equipment, where the data value itself does not need to be communicated to the equipment. For example, a timing interval for triggering a monitoring function may be stored in the miscellaneous registers, or a threshold value may be stored for comparison with a data value from one of the input registers (e.g., comparing a temperature sensor reading with a threshold value to determine whether a piece of equipment is active or on standby, or is overheating).

Configuration registers 1208A and 1208B may be used to store configuration data for the one or more I/O ports of the web-serving device. These values may include, for example, the baud rate and parity control bits for a serial port, or control bits for the I/O mode of a flexible I/O port (e.g., digital input, digital output, analog input (using an analog-to-digital converter), or analog out (using a digital-to-analog converter)).

As alluded to in the above description, memory block 1209 may be used to store web pages (subject to the server-side include functionality), memory block 1210 may be used to store device drivers loaded through the IP network, and memory block 1211 may be used to store action scripts for implementing controlling and monitoring functions.

Thus, a method and apparatus for providing universal web-access functionality have been described. Although the present invention has been described with respect to certain specific embodiments, it will be clear to those skilled in the art that the inventive features of the present invention are applicable to other embodiments as well, all of which are intended to fall within the scope of the present invention.

What is claimed is:

1. An apparatus comprising:
a first electronic device having a first communication port, said first electronic device comprising:
one or more services configured to communicate with a second device through said first communication port;
a contention manager configured to:
receive a port request from said one or more services for control of said first communication port;
determine when to take control of said first communication port from a currently controlling service; and
transfer control of said first communication port to a requesting service;
a web server serving one or more web pages via a network link, said one or more web pages associated with said second device.

2. The apparatus of claim 1:
wherein said first device further comprises a second communication port; and
wherein said contention manager is configured to provide a communication path between said first communication port and said second communication port in response to a pass-through request.

3. The apparatus of claim 2, wherein said pass-through request is received from said one or more services.

4. The apparatus of claim 2, wherein said pass-through request comprises a first identifier associated with said first port and a second identifier associated with said second communication port.

5. The apparatus of claim 2, wherein said communication path is subject to a timeout parameter.

6. The apparatus of claim 5, wherein said pass-through request comprises said timeout parameter.

7. The apparatus of claim 6, wherein said timeout parameter is associated with the time between receipt of consecutive characters.

8. The apparatus of claim 2, wherein said communication path is subject to a data length parameter in said pass-through request.

9. The apparatus of claim 2, wherein said communication path is subject to a delimiter character specified in said pass-through request.

10. The apparatus of claim 1, wherein said port request comprises one or more timeout parameters.

11. The apparatus of claim 10, wherein said one or more timeout parameters comprise a per character timeout.

12. The apparatus of claim 10, wherein said one or more timeout parameters comprise an intial character timeout.

13. The apparatus of claim 1, wherein said port request comprises a port identifier.

14. The apparatus of claim 1, wherein said port request comprises a delimiter parameter.

15. The apparatus of claim 14, wherein said contention manager compares incoming data with said delimiter parameter.

16. The apparatus of claim 1, wherein said port request comprises a data length parameter.

17. The apparatus of claim 16, wherein said contention manager counts incoming data units and takes control of said first communication port when the number of said incoming data units reaches said data length parameter.

18. The apparatus of claim 1, wherein said web server is configured to serve web pages associated with configuring said first device.

19. The apparatus of claim 18, wherein said web pages associated with configuring said first device comprise one or more web elements for activating said one or more services.

20. An apparatus comprising:
a controller configured to send and receive control information through a first type of communication port;
a controlled device configured to receive and send said control information through said first type of port;
a web server device having a first port coupled to said controller and a second port coupled to said controlled device, wherein said first port and said second port are of said first type, wherein said web server device comprises:
a first service associated with said controller, said first service configured to initiate a request for a communication path between said first port and said second port when said controller sends said control information to said first port;
a second service associated with said controlled device, said second service configured to initiate a request for said second port to communicate with said controlled device; and
a contention manager configured to transfer control of said second port to a requesting service when said second port is available, said contention manager further configured to monitor use of said second port based on parameters associated with a current request.

21. The apparatus of claim 20, wherein said second service is an executed script.

22. The apparatus of claim 20, wherein said web server device is coupled to a browser over a network connection, said web server device serving one or more web pages for a user to have an interaction with said controlled device through said second service.

23. The apparatus of claim 22, wherein said interaction comprises control.

24. The apparatus of claim 22, wherein said interaction comprises monitoring of said controlled device.

25. The apparatus of claim 20, wherein said first type of port comprises a serial port.

26. In a device having a plurality of services sharing one or more common ports, a method for managing port contention comprising:
receiving a request from a service for control of a port, said request comprising one or more parameters;
transferring control of said port to said service when said port is available; and
rescinding control of said port by said service based upon said parameters, making said port available to other services.

27. The method of claim 26, wherein said request is a pass-through request and said one or more parameters comprise at least two port identifiers between which a communication path is to be obtained.

28. The method of claim 26, wherein said parameters comprise one or more timeout values.

29. The method of claim 28, wherein said one or more timeout values comprise a per character timeout.

30. The method of claim 28, wherein said one or more timeout values comprise an initial character timeout.

31. The method of claim 26, wherein said parameters comprise delimiter criteria against which incoming data is compared.

32. The method of claim 26, wherein said parameters comprise a data length against which a count of incoming data units is compared.

33. A method for inserting a web server device into a communication path between a first device and a second device, comprising:
coupling said first device to a first port of said web server device;
coupling said second device to a second port of said web server device;
in response to detection of a transmission from said first device,
obtaining a pass-through request for a pass-through connection between said first port and said second port;
providing said pass through connection when said second port is available;
maintaining said pass-through connection until termination criteria in said pass-through request are satisfied;
in response to a port request for control of said second port from a service in said web server device,
providing control of said second port to said service when said second port is available; and
maintaining control of said second port by said service until termination criteria in said port request are satisfied.

34. The method of claim 33, further comprising providing communication between a user and said second device through one or more served web pages when said service has control of said second port.

35. The method of claim 33, wherein said termination criteria comprise one or more timeout values.

36. The method of claim 33, wherein said termination criteria comprise a delimiter character that is compared with incoming data.

37. The method of claim 33, wherein said termination criteria comprise a data length value that is compared with a count of incoming data units.
